(19) United States
(12) Patent Application Publication
(10) Pub. No.: US 2013/0242098 A1
(43) Pub. Date: Sep. 19, 2013

(54) TRAFFIC INFORMATION SYSTEM

(71) Applicant: GM GLOBAL TECHNOLOGY OPERATIONS LLC, Detroit, MI (US)

(72) Inventors: Uwe HAHNE, Buettelborn (DE); Christoph SCHMIDT, Wiesbaden (DE)

(73) Assignee: GM GLOBAL TECHNOLOGY OPERATIONS LLC, Detroit, MI (US)

(21) Appl. No.: 13/779,244

(22) Filed: Feb. 27, 2013

(30) Foreign Application Priority Data
Mar. 17, 2012 (DE) 10 2012 005 471.8

(51) Int. Cl. G08G 1/0967

(52) U.S. Cl. CPC G08G 1/096766
USPC 348/148

(57) ABSTRACT

A traffic information system includes first vehicles equipped with first optical sensor means. An image of an environment of the first vehicles is generated with the first optical sensor means and includes as associated image attributes: a current position of the first vehicles at which the image was generated, a time at which the image was generated, and a viewing direction with which the image was generated. The image and the associated image attributes of the environment of the first vehicles are communicated to a network and the image and the associated image attributes are at least buffered in the network. A second vehicle comprises a utilisation device that includes an input means and a display means. An image relating to a position POI in a road transport network is retrieved via the utilisation device from the network and the image is displayed on the display means.

### CROSS-REFERENCE TO RELATED APPLICATION

This application claims priority to German Patent Application No. 10 2012 005 471.8, filed Mar. 17, 2013, which is incorporated herein by reference in its entirety.

### TECHNICAL FIELD

The technical field relates to a traffic information system with which images of an environment of a specifiable position can be displayed in a vehicle.

### BACKGROUND

Displaying images of an immediate vehicle environment on a navigation device is known according to the state of the art. As such the US 2009/0125234 A1 discloses a navigation device connected with a vehicle camera of a vehicle, on the screen of which can be displayed an image of the actual environment of the vehicle as it is recorded by the vehicle camera. Navigation remarks are projected onto or into the displayed environment image, wherein the driver can see these navigation remarks being displayed for example on the screen of the navigation device against the background of an environment currently perceived by him. The disadvantage is that it is possible only for the immediate and momentarily present environment within the field of vision of the camera of the vehicle to be recorded and displayed.

Accordingly, it is desirable to provide a traffic information system, with which images of an environment of a specifiable position POI (position of interest), which does not correspond to the vehicle position, can be displayed in a vehicle. In addition, other objects, desirable features and characteristics will become apparent from the subsequent summary and detailed description, and the appended claims, taken in conjunction with the accompanying drawings and this background.

### SUMMARY

In accordance with an exemplary embodiment, a traffic information system comprises:

a plurality of first vehicles equipped with a first optical sensor means, wherein images of an environment of a respective first vehicle can be generated with a first optical sensor means, wherein each of these images comprises, as image attributes: a current position of a first vehicle at which the image was generated, a time at which the image was generated, and a viewing direction of the sensor means with which the image was generated,

a network to which generated images and associated image attributes of the respective first vehicle can be communicated and in which the communicated images and associated image attributes can at least be buffered, and

one or more second vehicle equipped with a utilisation device, wherein the utilisation device comprises an input means and a display means, wherein images relating to a position POI in a road transport network, which position is specifiable via the input means or ascertainable by a navigation system of the second vehicle, can be retrieved via the utilisation device from the network and the retrieved images can be displayed on the display means.

The traffic information system is based on the fact that a plurality of vehicles, for example, 40%, 50%, 60%, 70%, 80%, 90% or 100% of vehicles driving in a road transport network, are equipped, respectively, with a first optical sensor means (and thus in terms used herein are first vehicles) and continually or depending upon a driving state (for example a stationary or moving first vehicle) of the respective first vehicle, take pictures of the respective environment of the vehicle and communicate these with at least the above mentioned image attributes to the network. It would, of course, be possible to communicate further image attributes or additional information with a respective image, such as local weather information (temperature, precipitation, wind direction/speed, etc.). In an embodiment, the first sensor means records the respective vehicle environment in a driving direction. One can, of course, also use a first sensor means to take a picture of a large section of the environment, for example at an azimuth angle of 90°, 180°, 260° or 360° and communicate this to the network, or a first sensor means to additionally or alternatively record an environment contrary to the driving direction of the first vehicle and communicates this to the network.

In an embodiment, the first optical sensor means operates automatically, i.e. without necessary interference by the driver. Provision may be made, of course, in a first vehicle, to manually disable the communication of images of the first sensor means to the network. Furthermore, in an embodiment, for reasons of data protection, data communication from the respective first vehicle to the network takes place in such a way that identification of the respective first vehicle is impossible.

In another embodiment, the images existing in the network cover the entire road transport network, i.e. several up-to-date images of the associated environment are retrievably stored in the network for each position of the road transport network. The images communicated to the network by the first vehicles are at least buffered in the network. The buffer time of an image for a position, in an embodiment, depends upon how often new images are communicated for this position, i.e. how often environment images for this position are updated. If the position lies for example along a much used motorway, many first vehicles will pass this position in short intervals of time resulting in a high update rate of the corresponding environment image. The buffer time may be shortened. The case is different for a less used secondary route. The update rate for a position along this secondary route is low so that the buffer time can be set correspondingly long. In an embodiment, at least one up-to-date image is retrievably stored in the network for each position of the road transport network. It is thus possible for a second vehicle equipped with a utilisation device according to an embodiment to retrieve one or more images from the network relating to a position POI in a road transport network, which position is specifiable via the input means or ascertainable by a navigation system of the second vehicle, and to display the retrieved images on the display means. Furthermore, in an embodiment, each second vehicle is also equipped with a first optical sensor means so that in this case a first vehicle is at the same time a second vehicle.

In a further embodiment, retrieving the images from the network comprises identifying images stored in the network by means of preset criteria (at least position POI and possibly additionally viewing direction and/or time) and their communication to the second vehicle or its navigation system. If no images of a polled position POI exist in the network, retrieval comprises a message that no corresponding images are available plus an additional remark regarding the existence of alternative images.

The first optical sensor means could be a plurality of devices. Non-limiting examples are conventional framing or video cameras that operate within the visible wavelength range, respective cameras with residual light amplifiers, infrared cameras or sensors, for example, imaging sensors operating with wavelengths not visible to the human eye such as wavelengths within the radar range or ultrasound. According to an exemplary embodiment, a vehicle comprises at least one video camera as a first sensor means, operating within the visible wavelength range.

The first optical sensor means are used to record images of the environment of the current position of the vehicle. Each vehicle representing a part of the traffic information system comprises at least one sensor means which then points, for example, in a forward driving direction and records the environment in front of the vehicle. In a further embodiment, alternative or additional sensor means point in other directions, for example, in the reversing direction. In another embodiment, a combination of several sensor means in various ways record the same area or an overlapping area of the environment, for example within the visible wavelength range or additionally within other ranges of the electro-magnetic wave spectrum or within the ultrasound range. As such, images can also be advantageously provided in fog or at night, where first optical sensor means limited to recording within the visible wavelength spectrum can supply only limited image information.

The images of the environment generated by the first optical sensor means at the current position of the respective vehicle comprise further image attributes in addition to the image information as such. Essential image attributes are position data of the optical sensor means with which the image was recorded, at the time of recording. This position data can be provided, for example, by navigation systems in the respective first vehicles. A further essential image attribute is the time at which an image was recorded, and the viewing direction of the sensor means with which the image was recorded. It will be clear that on the basis of this data the recorded field of view of the sensor means is ascertainable. If, for example, a video camera is aligned exactly in parallel with the longitudinal axis of the vehicle in forward direction, the viewing direction of this video camera and thus essentially the recorded field of view can be calculated from the position of the vehicle and its orientation or driving direction with the help of trigonometric processes. Analogue calculations can be performed where a sensor means is aligned in lateral direction, i.e., parallel to the transverse axis of the vehicle or obliquely at an angle to the longitudinal or transverse axis.

Non-limiting examples for further additional image attributes are the focal length of a used objective of a sensor means, its angle of view, the elevation of the optical axis relative to the horizontal plane, the type of image-recording sensor means, or the wavelength range used for recording.

The time at which the image was recorded can be ascertained via conventional timers. Each individual image may comprise a corresponding indication of the time. Alternatively, for a sequence of images such as a video sequence, the point in time of recording each individual image can be ascertained if at least one image comprises a time indication and the image sequence frequency of image recording is known.

In an exemplary embodiment, the network to which the generated images and associated image attributes are communicated comprises communication means for wired and/or non-wired data communication with which images from the first sensor means of the first vehicles and requests for images from the utilisation device of the second vehicle can be received and images or error messages can be sent to the utilisation device. The network further comprises a data store for buffering the images, for example, data processing units, with which requests from an utilisation device can be processed. The network may comprise any network structure known in the art.

According to an exemplary embodiment, a central network architecture is present in which each first vehicle, directly or via corresponding communication paths of the network, communicates images and associated image attributes of the first optical sensor means in the vehicle to a central point, for example, a central computer or a central computing unit. Alternatives are decentralised network structures, ad-hoc networks, and self-organising networks. The network may also utilise so-called car-to-car and/or car-to-X data transmissions.

The network performs at least buffering of the images and image attributes. Accordingly these are then available for retrieval not only at the time of recording and communicating but also afterwards for a defined period of time. The period of time is selectable depending on the intended application or the network used and lies for example within a range of minutes, hours, days, weeks, months, years or decades. If the intended application is a traffic information for up-to-date traffic information, in an embodiment buffering takes place over a period of time of up to 10, 20, 30, 45, 60 or 120 minutes resulting in images of a corresponding maximum age or reflecting traffic situations dating back that long. If the intended application is, however, the provision of an encyclopaedic retrieval of views of an environment in the past, for example, for illustrating seasonal changes or for tracking constructional changes or changes in the landscape, buffering can take place over months, years or decades. In an embodiment, when buffering is carried out over long periods of time, the amount of data is reduced by means of data compression or reduction of the image recording rate.

The utilisation device comprises an input means and a display means. The input means is used by an operator to specify which images are retrieved by the network and shall be output on the display means. Alternatively the selection of images may not be carried out via an input at the input means, but via a position POI ascertainable by the navigation system. This is, for example, the case if the position POI is ascertained by the utilisation device on the basis of a current vehicle position POI and a route.

The input means may be solutions known in the art such as keyboards, operating knobs, cursor or mouse controls, speech commands that are recognised and translated by associated speech recognition systems, or touch-sensitive screens, on which function keys triggering desired commands or positions can be directly chosen on a representation of a map.

The display means may be devices known in the art such the screens of permanently installed or separate mobile navigation systems, or further screens present in the vehicle, such as screens of a vehicle information system. In one embodiment, the display means comprises a head-up display. The display means is arranged, for example, inside the driver's cabin so as to be visible to the driver; alternatively, it may also be additionally provided in the rear of the vehicle, for example, in the rear surface of the front seats or as a foldable unit in the arm rest.

The communication of the images from a first vehicle to the network may be in the form of a continuous data stream. Alternatively, the images could be transmitted in intervals of time and/or dependent upon the driving state of the respective first vehicle. If, for example, the vehicle is caught in a traffic jam, its position is unchanged and thus the image of the environment is also unchanged, therefore the communication of constantly equal images to the network in this driving state would not make any sense.

According to one embodiment, the traffic information system additionally comprises second optical sensor means fixedly arranged in the road transport system, with which images of an environment of the respective second sensor means can be generated. Each of these images comprises, as image attributes: a position of the respective second sensor means, a time at which the image was generated, and a viewing direction of the second sensor means with which the image was generated, and the images and image attributes from the second optical sensor means can be communicated to the network and are at least buffered in the network. The devices for these second optical sensor means may, among others, be the same as described above in connection with the first optical sensor means. Examples of actual designs envisage fixedly arranged traffic cameras, in particular within the visible or infrared wavelength range. Further examples propose environmental cameras often called street cams, with which, according to the definition mentioned in the beginning, not only or exclusively, traffic situations can be recorded, but also environmental situations at geographical locations, where the term traffic or road traffic in particular, would not be the correct word used. It is pointed out that the term road transport network does encompass both drivable roads as well as areas in between. For example, images of an environment of a position in a park or an attractive landscape could be recorded and communicated to the network, wherein the position is remote from a drivable road.

The traffic information system according to an embodiment provides for a wide range of image sequence frequencies. If the buffered images are to be used to track seasonal changes or constructional changes or changes in the landscape, individual images may be recorded in intervals of days, weeks, months or years, or in the extreme case, the recordings may be irregular, therefore an image sequence frequency would not arise. In particular for the communication of information relating to essentially current traffic situations, the traffic information system according to an embodiment provides for image sequence frequencies in the range from about 0.001 Hz to about 100 Hz. Particularly suitable frequencies are image sequence frequencies in the range from about 0.2 Hz to about 25 Hz. Using these ranges, traffic situations at the lower threshold can be reproduced as still meaningful with storage requirements reduced, and video sequences at the upper threshold can be displayed as a video sequence which to the human eye is flowing.

According to one embodiment of the traffic information system the utilisation device is realised and adapted in such a way as to allow images to be retrieved by the network, which relate to a time specified via the input means and/or which are taken in a specified viewing direction. For a specified time various designs are possible. For example, this may relate to an actual point in time. As such, a user or operator of the traffic information system may request the retrieval of images for a defined position, which images were recorded at exactly a certain time of day or prior to a defined time span, relative to the actual time of day. Alternatively one could stipulate that the images must have been recorded at a certain time interval, for example within the last quarter hour. The image attributes which also comprise the point in time at which the image is recorded, or which allow the point in time to be calculated, may be used to select and retrieve (and therefore to communicate to the vehicle or its navigation system), among the buffered images, those which correspond to the time criterion defined by the user.

The specified viewing direction is also comprised in the image attributes. From the position for which images are to be retrieved, and the viewing direction from which the images are to be recorded by the sensor means, it can be ultimately determined which view of an object present at this position shall be displayed on the display means. If, for example, the position relates to a motorway with two opposite motorway exits in opposite driving directions, or for example a multi-story car park with a northern entry and a southern entry, it can be determined via the viewing direction which of the motorway exits shall be displayed, or whether the northern entry or the southern entry of the car park shall be displayed.

A further embodiment provides for the position POI to be ascertainable by the navigation system based on a current position Pₐₖₜ of the vehicle and a specifiable trip duration at an anticipated vehicle speed along a specified or anticipated route in the road transport network. The specifiable time duration corresponds to a lead time. This means that a user in a second vehicle can retrieve images at the current point in time about the position POI at which presumably he will be at a specified point in time in the future. If the second vehicle happens to be driving along a current route selected in the navigation system of the vehicle, it can be estimated, on the basis of the current position Pₐₖₜ of the vehicle, the local conditions along the route such as traffic lights, speed limits and such like, and the average speed of the vehicle, from which conclusions can be drawn regarding the volume of traffic and thus the advance of the vehicle in the traffic flow, to which geographic position POI the selected lead time corresponds. If, on the other hand, the vehicle is not following a route selected in the navigation system, a preliminary route may be used as a basis at least based on the currently used road and its local conditions, so that based on the average speed a geographic position POI corresponding to the lead time is ascertainable. In both cases the user does not specify absolute positions POI for the images to be retrieved, rather the positions POI are ascertained by the utilisation device depending upon the momentary vehicle location. Advantageously a user currently driving along a motorway can thus retrieve images for positions which he will reach according to the lead time, such as after 5, 10 or 15 minutes driving time. If the images indicate traffic problems such as congestions at these positions the user can adjust to them and, as required, avoid the problems by leaving the motorway beforehand.

In a further embodiment, the utilisation device is implemented and adapted in such a way that in a second vehicle requesting images, a local lead time can be selected with which the images for a selectable geographic position POI are to be provided. The position POI is ascertained by the navigation system based on a current position Pₐₖₜ of the vehicle along a specified or anticipated route in the road transport network, and a specifiable distance of the position POI from the current position Pₐₖₜ along the route. For example, a user can request images for a position POI which, for example, lies 200 m, 1 km, 5 km or 10 km ahead of the current position of the respective second vehicle.

With the two embodiments mentioned above with lead time or local lead time the requested images may be retrieved completely or without gaps if many first vehicles are equipped with first sensor means which transmit images to the network for buffering. If only a few images are stored in the network which do not completely cover a requested position POI or if there are gaps in its coverage, in particular for a specified lead time, provision is made according to a further embodiment, in case suitable image material is missing, for no image to be displayed at times to the user, or alternatively a message that images are missing, or a message saying that the last image displayed is no longer current. As soon as an image can again be retrieved which meets the criteria specified by the user, it is output on the display means, possibly with an indication that a suitable image is again displayed.

According to a further embodiment, the lead time or local lead time is selectable via an input means which is implemented as a slide control. This may be a mechanical slide control implemented as an actual fitting or as a virtual slide control implemented on the display means. In particular in the last mentioned case an additional further embodiment may provide for different scales to be settable for the slide control, for example local lead times in the range from about 0 to about 1 km, about 1 to about 10 km or about 10 to about 100 km. For a specified scale of this kind the network is continuously or periodically polled for the lead times for which images are actually retrievable, for example along a selected or anticipated driving route, with corresponding scale positions being represented as being selectable on the slide control, whilst other scale positions for which no images are available are represented as not being selectable.

A further embodiment of the traffic information system provides for a tolerance range about the specified position POI to be specifiable via the utilisation device, and given the case that no image is available in the network for the specified position POI, images for a position within the tolerance range are retrieved and displayed. If, for example a user wants to retrieve images relating to a position POI which is distant by 3 km from the current position Pₐₖₜ of the second vehicle and suitable images are missing and a tolerance range of 500 m has been set, existing images can be retrieved and displayed, which correspond to a position distant by about 3.5 km from the current position Pₐₖₜ, or which are distant by about 500 m from the selected position POI. The tolerance range can thus relate to a local tolerance range. Provision is also made for a time tolerance range, wherein based on the above-discussed correlations between momentary position POI of the respective second vehicle, its driving route or driving direction and speed, each time tolerance range can be converted into a local tolerance range. If for example the user desires a lead time of 10 minutes, but there are no suitable images and the time tolerance range is 2 minutes, images may be retrieved and displayed which correspond to a lead time of about 9 minutes or about 11 minutes. A further embodiment provides for a message being output regarding missing suitable images, if no images at all are available, neither for a selected local tolerance range nor for a selected time tolerance range.

According to a further embodiment of the traffic information system, one or more sensor means can be selected from a summary of sensor means, the images of which are to be displayed in the vehicle. The summary may be present in list form which for example gives the positions as geographic coordinates and/or descriptive names such as “motorway exit Ax in driving direction”, or which may be embedded directly into a map representation on the display means.

### BRIEF DESCRIPTION OF THE DRAWINGS

The various embodiment will hereinafter be described in conjunction with the following drawing figures, wherein like numerals denote like elements, and wherein:

FIG. 1 shows a schematic representation of the traffic information system in accordance with an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

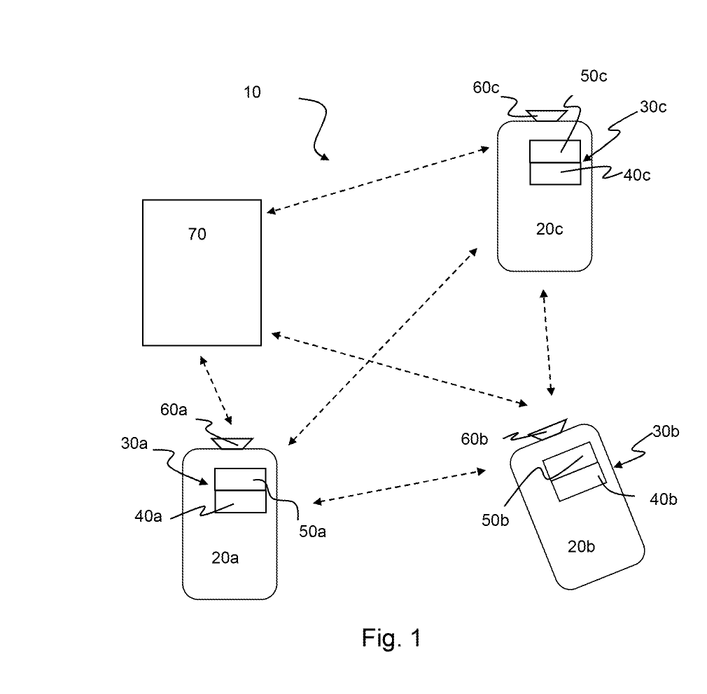

FIG. 1 shows a schematic representation of the traffic information system in accordance with an exemplary embodiment. The traffic information system comprises three first vehicles 20a, 20b, 20c equipped, respectively, with a first optical sensor means 60a, 60b, 60c, wherein images of an environment of the respective first vehicle 20a, 20b, 20c are continuously generated by the first sensor means 60a, 60b, 60c. Each of the images generated comprises as image attributes: a current position Pₐₖₜ of the respective first vehicle 20a, 20b, 20c, at which the image was generated, a time at which the image was generated, and a viewing direction of the first sensor means 60a, 60b, 60c, with which the image was generated. The first vehicles 20a, 20b, 20c together with a central computer 70 comprising storage means for storing images, form a radio network 10. The arrows depicted as dotted line in FIG. 1 show the interconnection between the first vehicles 20a, 20b, 20c and the central computer 70. The present network comprises a central network architecture.

The images including the image attributes generated by the respective first sensor means 60a, 60b, 60c, are continuously communicated by the respective first vehicles 20a, 20b, 20c to the central computer 70 and are buffered by the latter for a time of about 120 minutes. Apart from these images it is assumed that the central computer has retrievably stored images from other first vehicles not shown, of respective position environments for each position in a road transport network.

In the present embodiment all first vehicles 20a, 20b, 20c are equipped with a utilisation device 30a, 30b, 30c so that these first vehicles 20a, 20b, 20c are also second vehicles. The utilisation device 30a, 30b, 30c respectively comprise an input means 40a, 40b, 40c and a display means 50a, 50b, 50c. Images relating to a position POI in the road transport network, specifiable via the input means 40a, 40b, 40c may be retrieved via the utilisation device 30a, 30b, 30c from the network or, in the present embodiment, from the central computer 70 and the retrieved images may be displayed on the display means 50a, 50b, 50c.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A traffic information system comprising:
a plurality of first vehicles equipped with a first optical sensor means, wherein an image of an environment of each of the plurality of first vehicles is generated with the first optical sensor means, wherein the image comprises, as associated image attributes: a current position of each of the plurality of first vehicles at which the image was generated, a time at which the image was generated, and a viewing direction of the first optical sensor means with which the image was generated;
a network to which the image and the associated image attributes of the environment of each of the plurality of first vehicles are communicated and in which the image and the associated image attributes are at least buffered; and
a second vehicle comprising a utilisation device, wherein the utilisation device comprises an input means and a display means, wherein an image relating to a position POI in a road transport network, which position is specifiable via the input means or ascertainable by a navigation system of the second vehicle, is retrieved via the utilisation device from the network and the image is displayed on the display means.

2. The traffic information system according to claim 1, wherein a second optical sensor means is fixedly arranged in the road transport network, with which an image of an environment of the second optical sensor means is generated, wherein the image comprises, as image attributes: a position of the second optical sensor means, a time at which the image was generated, and a viewing direction of the second optical sensor means with which the image was generated, and the image is communicated to the network by the second optical sensor means and is at least buffered in the network.

3. The traffic information system according to claim 2, wherein the first optical sensor means and/or the second optical sensor means are configured and adapted such that the image is generated at an image sequence frequency in a range of from about 0.001 HZ to about 100 Hz.

4. The traffic information system according to claim 1, wherein the utilisation device is configured such that an image is retrieved from the network for the position POI specified via the input means or ascertained by the navigation system for a specifiable time and/or for a specifiable viewing direction.

5. The traffic information system according to claim 1, wherein the network is configured for buffering the image communicated to the network for a maximum period of time in a range of from about 10 minutes to about 120 minutes.

6. The traffic information system according to claim 1, wherein the position POI is ascertained by the navigation system on a basis of a current position Pₐₖₜ of the second vehicle along a specified or anticipated route in the road transport network, and a specifiable distance of the position POI from the current position Pₐₖₜ along the route.

7. The traffic information system according to claim 1, wherein the position POI is ascertained by the navigation system on a basis of a current position Pₐₖₜ of the second vehicle and a specifiable trip duration for an anticipated vehicle speed along a specified or anticipated route in the road transport network.

8. The traffic information system according to claim 1, wherein by the input means a tolerance range is specifiable about the position POI, and in case that no image is available in the network for the position POI, an image for a position POI′ nearest to the position POI within the tolerance range is retrieved from the network by the utilisation device and displayed.

9. The traffic information system according to claim 1, wherein the utilisation device is configured such that a table with a number of first and/or second optical sensor means is displayed, and a first and/or second sensor means is selected from the table, the image of which is retrieved from the network and displayed.

10. The traffic information system according to claim 1, wherein the display means comprises a head-up display with which images retrieved from the network are displayed.

11. The traffic information system according to claim 1, wherein the utilisation device is identical to the navigation system.
